(19) United States
(12) Patent Application Publication
(10) Pub. No.: US 2009/0153912 A1
(43) Pub. Date: Jun. 18, 2009

(54) Scanner Calibration Strip, Scanner, and Method for Segmenting a Scanned Document Image

(76) Inventors: Mohamed Nooman Ahmed, Louisville, KY (US); Chengwu Cui, Lexington, KY (US); Ahmed Hamad Mohamed Eid, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/958,768

(22) Filed: Dec. 18, 2007

(51) Int. Cl. H04N 1/00

(52) U.S. Cl. 358/406; 358/408

(57) ABSTRACT

A scanner calibration strip medium is described which includes at least one of a plurality of text symbols and a plurality of halftoned non-text images. A scanner is described which includes a scan bar and a scanner calibration strip medium scannable by the scan bar. The calibration strip medium includes a plurality of text symbols having text pixels and a plurality of halftoned non-text images having halftoned non-text pixels. A method for segmenting a scanned document image into text symbols and halftoned non-text images is described which uses a scanner calibration strip medium which includes a plurality of text symbols having text pixels and a plurality of halftoned non-text symbols having halftoned non-text pixels, wherein the calibration strip medium has a known pixel classification including which pixels of the calibration strip medium are text pixels and which pixels of the calibration strip medium are halftoned non-text pixels.

### TECHNICAL FIELD

The present invention relates generally to scanning documents, and more particularly to a scanner calibration strip, to a scanner, and to a method for segmenting a scanned document image into text symbols and halftoned non-text images.

### BACKGROUND OF THE INVENTION

Scanners are used to scan an image to create a scanned image which can be displayed on a computer monitor, which can be used by a computer program, which can be printed, which can be faxed, etc. Conventional scanners include a housing having a calibration strip which includes a rectangular calibration strip medium which has a scannable, completely white surface having a predetermined level of “whiteness”. The scanner also includes a controller and a scan bar having a linear array of sensor (i.e., optical sensor) elements. Each sensor element produces a signal proportional to the amount of light reaching the element. The signal gives a light value of the pixel of the image read by that sensor element. System components are not perfect, and their performance may degrade over time.

At times during scanner operation, a scanned calibration image of the white calibration strip medium is obtained using the scan bar, and tone-correction filtering is performed on the light value read by each sensor element. The tone-correction filtering has filtering parameters whose values are determined so that the corrected (filtered) light value of the sensor element will ideally match the predetermined “whiteness” level of the white calibration strip medium. For subsequent scans, the light value read by each sensor element is adjusted using the determined filtering parameters for that sensor element.

A scanned document image may include text symbols and halftoned non-text images. Conventional image segmentation divides the scanned document image into areas of text symbols and areas of halftoned non-text images.

Segmentation algorithms having segmentation parameters are used to classify a read pixel as a text pixel or as a halftoned non-text pixel based on nearby pixels. Areas having a predetermined degree of “whiteness” are classified as background areas. Then, in one example, a first special filter is applied to the sensor element light values of an area having a text symbol to “sharpen” the text symbol, and a second special filter is applied to the sensor element light values of an area having a halftoned non-text image to suppress objectionable moiré patterns.

What is needed is an improved scanner calibration strip, an improved scanner, and an improved method for segmenting a scanned document image into text symbols and halftoned non-text images.

### SUMMARY OF THE INVENTION

A expression of an embodiment of the present invention is for a scanner calibration strip medium. The scanner calibration strip medium includes at least one of a plurality of spaced-apart text symbols and a plurality of spaced-apart, halftoned non-text images.

A second expression of an embodiment of the present invention is for a scanner including a scan bar, a scanner housing, and a scanner calibration strip medium disposed on the scanner housing and scannable by the scan bar. The scanner calibration strip medium includes a plurality of spaced-apart text symbols having text pixels and includes a plurality of spaced-apart, halftoned non-text images having halftoned non-text pixels.

A method of the present invention is for segmenting a scanned document image of a scanner into text symbols and halftoned non-text images. The scanner includes a scanner calibration strip medium. The scanner calibration strip medium includes a plurality of spaced-apart text symbols having text pixels and includes a plurality of spaced-apart, halftoned non-text text symbols having halftoned non-text pixels. The scanner calibration strip medium has a known pixel classification including which pixels of the scanner calibration strip medium are text pixels and which pixels of the scanner calibration strip medium are halftoned non-text pixels.

The method includes obtaining a scanned calibration image of the scanner calibration strip medium, wherein the scanned calibration image includes pixels having light values. The method also includes performing a tone-correction filtering of the light values of the scanned calibration image using filtering parameters each having a value and performing a segmentation of the scanned calibration image into text symbols and halftoned non-text images without using the pixel classification of the scanner calibration strip medium, wherein the segmentation uses segmentation parameters each having a value. The method further includes adjusting the values of the filtering parameters and the values of the segmentation parameters, as required, for a subsequent tone-correction filtering and segmentation of the scanned calibration image to better match the pixel classification of the scanner calibration strip medium. The method also includes tone-correction filtering the scanned document image using the adjusted values of the filtering parameters and segmenting the scanned document image using the adjusted values of the segmentation parameters.

Several benefits and advantages are derived from the scanner calibration strip, the scanner, and/or the method of the present invention. In one example, the method improves the accuracy of classifying pixels of a scanned document image as pixels of a text symbol or as pixels of a halftoned non-text image. The method may be employed at various times to account for degradation in the performance of system components over time. Such improved segmentation of a scanned document image allows “sharpening” filtering to be applied only to a text symbol and allows “moiré-suppressing” filtering to be applied only to a halftoned non-text image, which together improves the quality of the scanned document image.

### BRIEF DESCRIPTION OF THE DRAWINGS

FIG. 1 is a schematic diagram of an embodiment of the invention including a scanner having a scanner calibration strip medium;

FIG. 2 is an enlarged view of a small portion of a text symbol of the scanner calibration strip medium of FIG. 1 showing four text pixels;

FIG. 3 is an enlarged view of a small portion of a halftoned non-text image of the scanner calibration strip medium of FIG. 1 showing four halftoned non-text pixels; and

FIG. 4 is a block diagram of a method of the present invention which can be performed by the scanner of FIG. 1.

### DETAILED DESCRIPTION

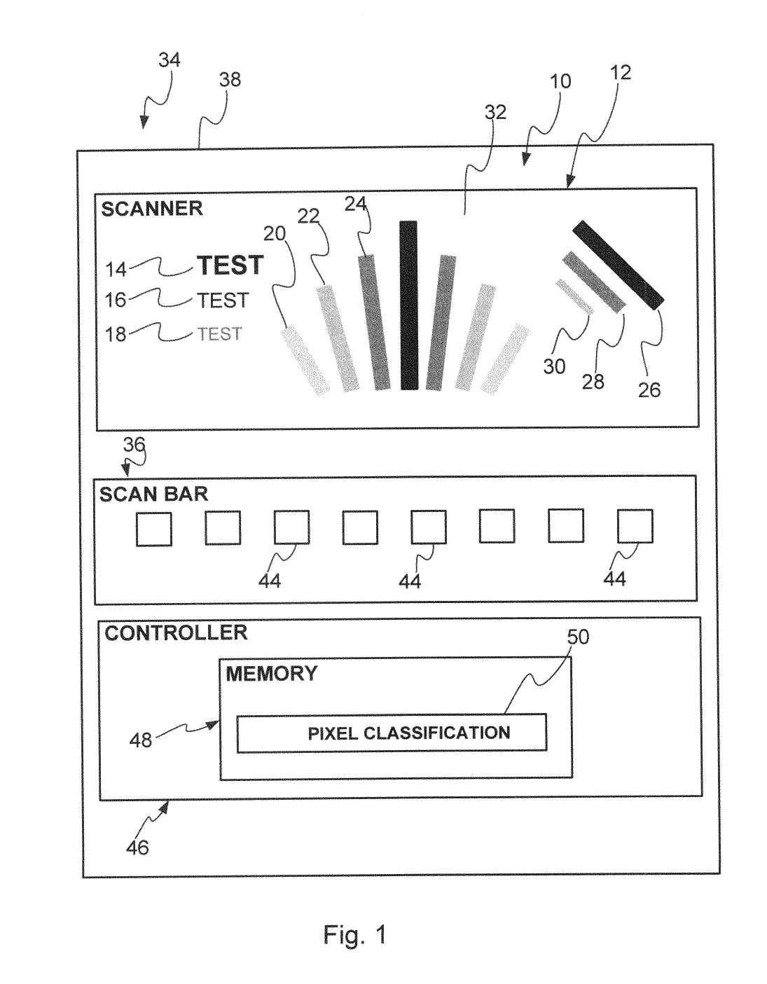

An embodiment of the present invention is shown in FIGS. 1 through 3. A first expression of the embodiment of FIGS. 1 through 3 is for a scanner calibration strip 10 including a scanner calibration strip medium 12. The scanner calibration strip medium 12 includes at least one of a plurality of spaced-apart text symbols 14, 16 and 18 and a plurality of spaced-apart halftoned non-text images 20, 22, 24, 26, 28 and 30. In one example, the scanner calibration strip medium 12 is paper or plastic and includes a light-colored background, such as a white background 32.

In other embodiments, the scanner calibration strip medium may be any material which is uniform, has a high reflectance and of a neutral tone. In an alternate embodiment, the scanner calibration strip medium 12 may be the scanner calibration strip 10. In another alternate embodiment, scanner calibration strip medium 12 may be embedded in the scanner calibration strip 10. In yet another alternate embodiment, the scanner calibration strip medium 12 may be attached or other otherwise adhered to the scanner calibration strip 10.

In one enablement of the first expression of the embodiment of FIGS. 1 through 3, the scanner calibration strip medium 12 includes the plurality of spaced-apart text symbols 14, 16, 18 and includes the plurality of spaced-apart halftoned non-text images 20, 24, 26, 28, 30. In one variation, the text symbols 14, 16, 18 each have a different resolution (as shown in FIG. 1) with a substantially same gray level. In one example, the text symbols 14, 16, 18 are the same type of text symbol (such as the letter “T” in FIG. 1). In one modification, the halftoned non-text images 20, 22, 24, 26, 28, 30 include images (such as halftoned non-text images 20, 22, 24 in FIG. 1) each having a different angle with a different gray level. In the same or a different modification, the halftoned non-text images 20, 22, 24, 26, 28, 30 include images (such as halftoned non-text images 26, 28, 30 in FIG. 1) each having a different resolution with a substantially same gray level.

In one implementation of the first expression of the embodiment of FIGS. 1 through 3, the scanner calibration strip medium 12 includes the plurality of spaced-apart text symbols 14, 16, 18. In one variation the text symbols 14, 16, 18 each have a different resolution (as shown in FIG. 1) with a substantially same gray level. In one example, the text symbols 14, 16, 18 are the same type of text symbol (such as the letter “T” in FIG. 1).

In one application of the first expression of the embodiment of FIGS. 1 through 3, the scanner calibration strip medium 12 includes the plurality of spaced-apart halftoned non-text images 20, 22, 24, 26, 28, 30. In one modification, the halftoned non-text images 20, 22, 24, 26, 28, 30 include images (such as halftoned non-text images 20, 22, 24 in FIG. 1) each having a different angle with a different gray level. In the same or a different modification, the halftoned non-text images 20, 22, 24, 26, 28, 30 include images (such as halftoned non-text images 26, 28, 30 in FIG. 1) each having a different resolution with a substantially same gray level.

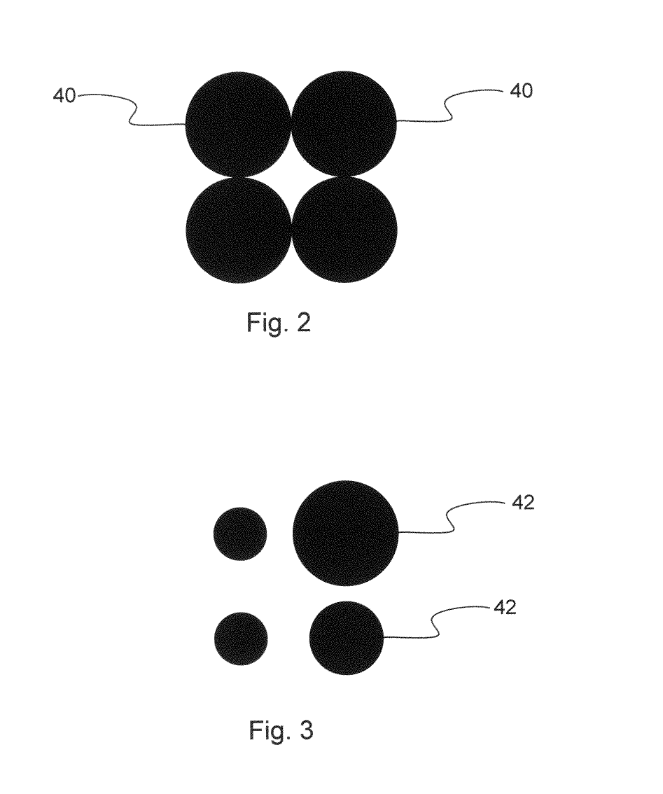

A second expression of the embodiment of FIGS. 1 through 3 is for a scanner 34 including a scan bar 36, a scanner housing 38, and a scanner calibration strip 10 disposed on the scanner housing 38 and scannable by the scan bar 36. The scanner calibration strip medium 12 includes a plurality of spaced-apart text symbols 14, 16, 18 having text pixels 40 (as shown in FIG. 2) and includes a plurality of spaced-apart, halftoned non-text images 20, 22, 24, 26, 28, 30 having halftoned non-text pixels 42 (as shown in FIG. 3). In one example, the scan bar 36 includes a plurality of optical sensor elements 44 each adapted to read one image pixel at a time, and the scanner calibration strip 10 is disposed in an area of the scanner 34 which is not visible to a user.

In one employment of the second expression of the embodiment of FIGS. 1 through 3, the scanner 34 also includes a controller 46 having a memory 48, wherein the scanner calibration strip medium 12 has a known pixel classification 50 including which pixels of the scanner calibration strip medium 12 are text pixels 40 and which pixels of the scanner calibration strip medium 12 are halftoned non-text pixels 42, and wherein the pixel classification 50 is stored in the memory 48 (such as in the form of a pixel-classification look-up table).

In one variation of the second expression of the embodiment of FIGS. 1 through 3, the text symbols 14, 16, 18 each have a different resolution (as shown in FIG. 1) with a substantially same gray level. In one example, the text symbols 14-18 are the same type of text symbol (such as the letter “T” in FIG. 1). In one modification, the halftoned non-text images 20, 22, 24, 26, 28, 30 include images (such as halftoned non-text images 20, 22, 24 in FIG. 1) each having a different angle with a different gray level.

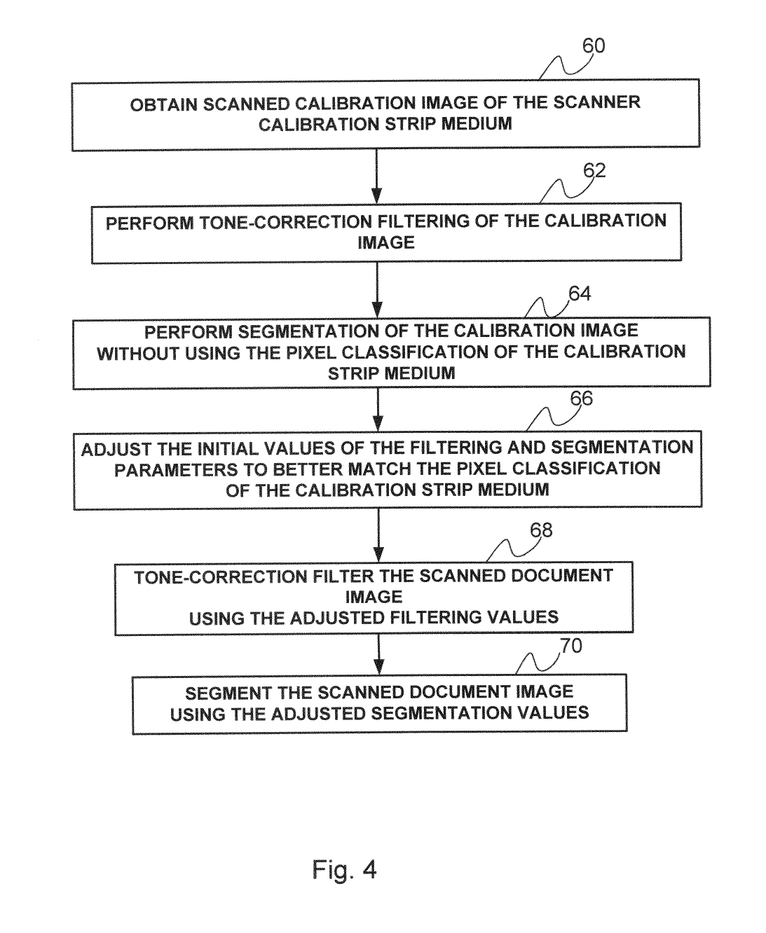

A method of the present invention illustrated in FIG. 4 is for segmenting a scanned document image of a scanner 34 into text symbols and halftoned non-text images. The scanner 34 includes a scanner calibration strip medium 12. The scanner calibration strip medium 12 includes a plurality of spaced-apart text images 14, 16, 18 having text pixels 40 and includes a plurality of spaced-apart, halftoned non-text text symbols 20, 22, 24, 26, 28, 30 having halftoned non-text pixels 42. The scanner calibration strip medium 12 has a known pixel classification 50 stored in memory 48, including which pixels of the scanner calibration strip medium 12 are text pixels 40 and which pixels of the scanner calibration strip medium 12 are halftoned non-text pixels 42.

Referring to FIG. 4, a scanned calibration image having pixels having light values of the scanner calibration strip medium 12 is obtained at block 60. At block 62, a tone-correction filtering of the light values of the scanned calibration image is performed using filtering parameters each having a value. Segmentation of the scanned calibration image into text symbols and halftoned non-text images is performed (block 64) without using the pixel classification 50 stored in memory 48 of the scanner calibration strip medium 12, wherein the segmentation uses segmentation parameters each having a value. At block 66, the values of the filtering parameters and the values of the segmentation parameters are adjusted, as required, for a subsequent tone-correction filtering and segmentation of the scanned calibration image to better match the pixel classification 50 stored in memory 48 of the scanner calibration strip medium 12. The illustrated method may also perform Tone-correction filtering the scanned document image using the adjusted values of the filtering parameters at block 68, and segmenting the scanned document image using the adjusted values of the segmentation parameters (block 70).

In one illustration of the exemplary method of FIG. 4, the value of each filtering parameter is obtained from a previous tone-correction filtering of the light values of a different scanned calibration image of a different white-only scanner calibration strip or of a white-only background area of the scanner calibration strip 10. In the same or a different illustration, the values of the filtering parameters and the values of the segmentation parameters are adjusted before the scanner scans the document to obtain the scanned document image. It is noted that the subsequent tone-correction filtering and segmentation of the scanned calibration image need not actually be performed.

In one extension of the exemplary method, wherein the scanner calibration strip 10 has a white background, a pixel of the scanned document image having a level of “whiteness” exceeding a predetermined value is considered to be a background pixel. In one arrangement, the light values range from 0 to 255, and in one example the white background of the scanner calibration strip is considered to have a light value substantially equal to 255.

Conventional tone-correction filtering algorithms and conventional scanned-image segmentation algorithms are well known in the art. In one realization of the method of FIG. 4, the values of the filtering parameters and the values of the segmentation parameters are adjusted together using a conventional genetic optimization algorithm. In one variation of the method, the text symbols 14, 16, 18 of the scanner calibration strip medium 12 each have a different resolution with a substantially same gray level. In one modification, the halftoned non-text images 20, 22, 24, 26, 28, 30 of the scanner calibration strip medium 12 each have a different angle with a different gray level.

An example of a conventional tone-correction filtering algorithm is:

y=αx^{1/γ}+(1−α)x^{γ}

and is implemented in a lookup table wherein y=the output value and x=the input value and a first filtering parameter α=0.1 to 0.9 in steps of 0.1 increments and a second filtering parameter γ=0.1 to 2.9 in steps of 0.2 increments. Another conventional tone-correction algorithm, may be used in alternate embodiments. One such conventional tone correction algorithm tested involved three filtering parameters and yielded results substantially equivalent to the two-filtering-parameter tone-correction algorithm described above.

An example of a conventional segmentation algorithm is as follows. A 5×5 mathematical window is slid over the scanned calibration image. Each pixel in the window is first passed through a lookup table employed by a conventional tone-correction filtering algorithm to adjust pixel intensities. Then modified edge detection is performed on the scanned calibration image as follows. If the absolute value of a particular neighboring pixel in the window minus the center (or other) pixel in the window is equal or greater than a particular value of a particular filtering parameter (e.g., a threshold value of a threshold parameter), then the center pixel is classified as a text pixel; otherwise the center pixel is classified as a halftoned image pixel. However, if the center pixel has a “whiteness” greater than a predetermined value, it is classified as a background pixel. The typical number of threshold parameters is seven with each having a limited dynamic range. A 5×5 window is found to work well for typical text sizes scanned at 600 dpi. Larger windows would be more appropriate for higher resolution scans.

To obtain the optimal adjusted filtering and segmentation parameters, an exhaustive search can be used since the number of parameters and the dynamic range of parameter adjustment is limited. Alternatively, a genetic algorithm can be used.

An example of a conventional genetic algorithm which optimizes the filtering and segmentation parameters together treats each parameter as a chromosome; concatenates the parameters to form a gene; uses a mutation rate of 0.005 and a crossover rate in the range of 0.95 to 0.99; uses 100 generations; and uses 20 genes in each generation. For each generation, a fitness function is used to determine the fitness of each gene. The fitness function is the inverse of the mean square error of how well particular values of the parameters cause the tone-correction filtering and segmentation of the scanned calibration image to match the pixel classification of the scanner calibration strip medium.

Several benefits and advantages are derived from the scanner calibration strip, the scanner and/or the method of the present invention. In one example, the method improves the accuracy of classifying pixels of a scanned document image as pixels of a text symbol or as pixels of a halftoned non-text image. The method may be employed at various times to account for degradation in performance of system components over time. Such improved segmentation of a scanned document image allows “sharpening” filtering to be applied only to a text symbol and allows “moiré-suppressing” filtering to be applied only to a halftoned non-text image which improves the quality of the scanned document image.

The foregoing description of several expressions of an embodiment and of a method of the present invention has been presented for purposes of illustration. It is not intended to be exhaustive or to limit the present invention to the precise actions and/or forms disclosed, and obviously many modifications and variations are possible in light of the above teaching. It is intended that the scope of the present invention be defined by the claims appended hereto.

What is claimed is:

1. A scanner calibration strip medium, comprising: at least one of a plurality of spaced-apart text symbols and a plurality of spaced-apart, halftoned non-text images.

2. The scanner calibration strip medium of claim 1, wherein the scanner calibration strip medium includes the plurality of spaced-apart text symbols and includes the plurality of spaced-apart, halftoned non-text images.

3. The scanner calibration strip medium of claim 2, wherein each of the plurality of spaced-apart text symbols has a different resolution with a substantially same gray level as the other text symbols in the plurality of spaced-apart text symbols.

4. The scanner calibration strip medium of claim 2, wherein each of the plurality of halftoned non-text images has a different angle with a different gray level as the other halftoned non-text images in the plurality of the half-toned non-text images.

5. The scanner calibration strip medium of claim 4, wherein each of the plurality of halftoned non-text images has a different resolution with a substantially same gray level as the other halftoned non-text images in the plurality of the half-toned non-text images.

6. The scanner calibration strip medium of claim 1, wherein the scanner-calibration-strip medium includes the plurality of spaced-apart text symbols.

7. The scanner calibration strip medium of claim 6, wherein each of the plurality of text symbols has a different resolution with a substantially same gray level.

8. The scanner calibration strip medium of claim 1, wherein the scanner calibration strip medium includes the plurality of spaced-apart, halftoned non-text images.

9. The scanner calibration strip medium of claim 8, wherein the each of the plurality of halftoned non-text images has a different angle with a different gray level.

10. The scanner calibration strip medium of claim 9, wherein each of the plurality of halftoned non-text images includes images having a different resolution with a substantially same gray level.

11. A scanner, comprising:
a scan bar;
a scanner housing; and
a scanner calibration strip medium disposed on the scanner housing and scannable by the scan bar, wherein the scanner calibration strip medium includes a plurality of spaced-apart text symbols having text pixels and includes a plurality of spaced-apart, halftoned non-text images having halftoned non-text pixels.

12. The scanner of claim 11, further comprising a controller having a memory, wherein the scanner calibration strip medium has a known pixel classification including which pixels of the scanner calibration strip medium are text pixels and which pixels of the scanner calibration strip medium are halftoned non-text pixels, and wherein the pixel classification is stored in the memory.

13. The scanner of claim 11, wherein the text symbols each have a different resolution with a substantially same gray level.

14. The scanner of claim 11, wherein the halftoned non-text images include images each having a different angle with a different gray level.

15. The scanner of claim 11, wherein the text symbols each have a different resolution with a substantially same gray level.

16. A method for segmenting a scanned document image of a scanner into text symbols and halftoned non-text images, wherein the scanner includes a scanner calibration strip medium having a plurality of spaced-apart text symbols having text pixels and includes a plurality of spaced-apart, halftoned non-text images having halftoned non-text pixels, wherein the scanner calibration strip medium has a known pixel classification including which pixels of the scanner calibration strip medium are text pixels and which pixels of the scanner calibration strip medium are halftoned non-text pixels, comprising:
obtaining a scanned calibration image of the scanner calibration strip medium, wherein the scanned calibration image includes pixels having light values;
performing a tone-correction filtering of the light values of the scanned calibration image using filtering parameters each having a value;
performing a segmentation of the scanned calibration image into text symbols and halftoned non-text images without using the pixel classification of the scanner calibration strip medium, wherein the segmentation uses segmentation parameters each having a value;
adjusting the values of the filtering parameters and the values of the segmentation parameters, as required, for a subsequent tone-correction filtering and segmentation of the scanned calibration image to better match the pixel classification of the scanner calibration strip medium;
tone-correction filtering the scanned document image using the adjusted values of the filtering parameters; and
segmenting the scanned document image using the adjusted values of the segmentation parameters.

17. The method of claim 16, wherein the light values range from 0 to 255.

18. The method of claim 16, wherein the initial values of the filtering parameters and the initial values of the segmentation parameters are adjusted together using a genetic optimization algorithm.

19. The method of claim 18, wherein the text symbols each have a different resolution with a substantially same gray level.

20. The method of claim 19, wherein the halftoned non-text images include images each having a different angle with a different gray level.
